(19) United States
(12) Patent Application Publication
(10) Pub. No.: US 2013/0250731 A1
(43) Pub. Date: Sep. 26, 2013

(54) WIND DIRECTION DETECTING SYSTEM AND METHOD USING SAME

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/612,685

(22) Filed: Sep. 12, 2012

(30) Foreign Application Priority Data
Mar. 20, 2012 (CN) 201210074237.5

(51) Int. Cl. G01S 3/80

(52) U.S. Cl. 367/118

(57) ABSTRACT

A wind direction detecting system of electronic apparatus includes an audio collecting module, a direction detecting module, and an analyzing module. The audio collecting module controls an audio collector to collect audio data at predetermined time intervals. The direction detecting module controls a direction sensor to detect a facing direction of electronic apparatus in relation to terrestrial magnetism each time the audio collector collects audio data. The analyzing module determines the facing direction where a greatest amplitude of the graph of audio data is recorded as the wind direction.

### 1. TECHNICAL FIELD

The disclosure generally relates to detection technologies, and particularly, to a wind detecting system and a method.

### 2. DESCRIPTION OF RELATED ART

A wind direction detecting system usually employs a rotatable structure to detect direction of wind. Because the rotatable structure is complicated and bulky, the wind direction system is unsuitable to be installed in a portable device, which is inconvenient.

Therefore, it is desirable to provide a wind direction detecting system and a method which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a wind direction detecting system.

FIG. 2 is a flowchart of one embodiment of a wind direction detecting method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

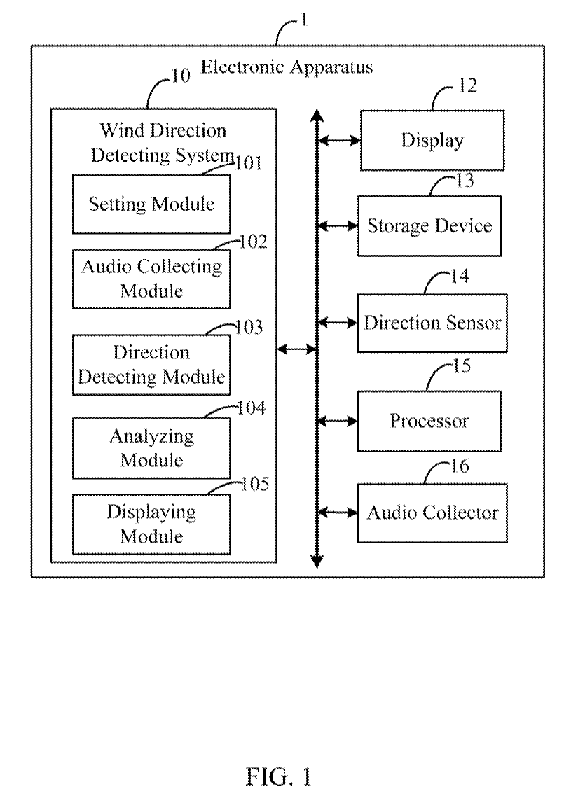

FIG. 1 is a block diagram of one embodiment of a wind direction detecting system 10 in an electronic apparatus 1. In one embodiment, the electronic apparatus 1 may include a display 12, at least one storage device 13, a direction sensor 14, at least one processor 15, and at least one audio collector 16. The display 12, the at least one storage device 13, the direction sensor 14, the at least one processor 15, and the audio collector 16 are directly or indirectly electrically connected for the exchange of data. In this embodiment, the electronic apparatus 1 may be, but is not limited to, a mobile intelligent terminal, such as, a tablet computer or a cellular phone.

The direction sensor 14 detects a value of terrestrial magnetism (magnetic effect value). The detected magnetic effect value changes when the electronic apparatus 1 faces different directions. The direction sensor 14 determines a facing direction of the electronic apparatus 1 according to the detected magnetic effect value. In this embodiment, the direction sensor 14 utilizes the Hall Effect principle to detect the facing direction of the electronic apparatus 1.

The audio collector 16 collects a graph of audio data generated by air flow passing over a surface of the electronic apparatus 1. The audio collector 16 includes a sensing surface (not shown) to sense a pressure of the air flow passing over. The pressure may be different when the sensing surface faces different directions, for example the pressure may reach a maximum value when the sensing surface directly faces the air flow, and the pressure may be reduced when the facing direction of the sensing surface is not squarely facing the air flow. The pressure may reach a minimum value when the facing direction of the sensing surface is same as the direction to which the air is flowing. The amplitude of the audio data collected may be obtained based on the pressure. When the pressure is greater, the amplitude of the audio data will be greater. Thus, the direction of the air flow can be established by analyzing the amplitudes within the collected audio data. It is understood that more than one audio collector can be set to face different directions for collecting the audio data. Thus, the audio data in different directions can be collected at the same time.

The storage device 13 may be, but is not limited to a hard disk, or a dedicated memory, such as an EPROM, HDD, or flash memory. The storage device 13 stores the magnetic effect values detected by the direction sensor 14 and the audio data collected by the audio collector 16.

In some embodiments, the display 12 may be, but is not limited to, a portable thin display, such as, a liquid crystal display, a light emitting diode display, or an organic light emitting diode display. Furthermore, the display 12 includes a touch panel to realize various touch control functions.

The wind direction detecting system 10 includes a setting module 101, an audio collecting module 102, a direction detecting module 103, an analyzing module 104, and a displaying module 105. Computerized codes of the wind direction detecting system 10 can be embedded into an operation system of the electronic apparatus 1, or stored in the storage device 13 and executed by the processor 15.

The setting module 101 presets at least one magnetic effect value corresponding to at least one reference direction. In detail, the direction sensor 14 detects the magnetic effect values when the electronic apparatus 1 faces reference directions, such as, the east, the south, the west, and the north. The setting module 101 stores the magnetic effect values corresponding to the reference directions in the storage device 13 and sets these magnetic effect values as the reference values for determining the facing direction of the electronic apparatus 1.

The reference direction is determined by what coordinate system is used, and is not limited to due east, due south, due west, and due north in the Cartesian coordinate system. For example, in alternative embodiments, a spherical coordinate system is used, and only one reference direction is needed.

The audio collecting module 102 controls the at least one audio collector 16 to records the graph of audio data generated by air flow passing over a surface of the electronic apparatus 1 at a predetermined time intervals.

The direction detecting module 103 controls the direction sensor 14 to detect the magnetic effect value each time the audio collector 16 collects audio data. The direction detecting module 103 compares the detected magnetic effect value with the reference values to determine the facing direction of electronic apparatus 1. The direction detecting module 103 stores the audio data and the corresponding facing direction which are acquired at same time in the storage device 13.

The analyzing module 104 selects the audio data having the greatest amplitude from all the collected and recorded audio data and determines the facing direction where a greatest amplitude of the graph of audio data is recorded as the wind direction.

The displaying module 105 displays the result of the analysis by the analyzing module 104.

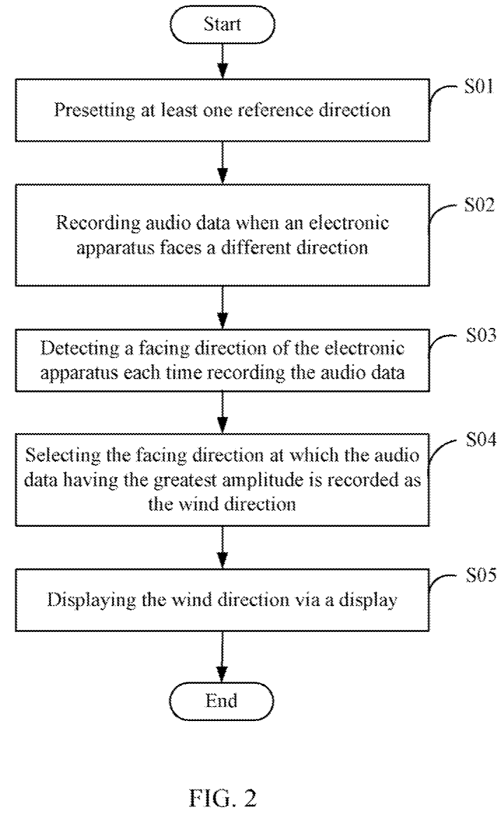

FIG. 2 is a flowchart of one embodiment of a wind direction detecting method for automatically detecting the wind direction without a rotatable structure. Depending on the embodiment, additional steps may be added, others deleted, and the ordering of the steps may be changed.

In step S01, in the presetting of at least one reference direction, the setting module 101 presets at least one magnetic effect value detected by the direction sensor 14 when the electronic apparatus 1 is facing at least one reference direction as at least one reference value. The at least one reference value is used to determine a facing direction of the electronic apparatus 1.

In step S02, in the collecting of the graph of audio data, the audio collecting module 102 controls the audio collector 16 to records the graph of audio data generated by air flow passing over a surface of the electronic apparatus 1. It is understood that, in order to improve the accuracy of the detection, the electronic apparatus 1 should face as many as directions as possible to collect the audio data. For example, the electronic apparatus 1 should face different directions around where it stands to collect the audio data. In alternative embodiment, a number of audio collectors are set to face different directions and to collect the audio data in different directions at the same time. The rotation of the electronic apparatus can be omitted.

In step S03, in the detection of the facing direction, the direction detecting module 103 controls the direction sensor 14 to detect the magnetic effect values each time the audio collector 16 collects audio data. The direction detecting module 103 determines the facing direction of electronic apparatus 1 according to the reference value. The direction detecting module 103 stores the audio data and the corresponding facing direction which are acquired at same time in the storage device 13.

In step S04, in analyzing the audio data, the analyzing module 104 compares amplitude of the audio data of different facing direction and determines the facing direction where a greatest amplitude of the graph of audio data is recorded as the wind direction.

In step S05, in displaying a result of the analysis, the analyzing module 104 transmits the result(s) of the analysis to the displaying module 105. The displaying module 105 displays the result(s) via the display 12.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An electronic apparatus for detecting a wind direction, comprising:
a direction sensor that detects a facing direction of the electronic apparatus;
an audio collector that records a graph of audio data generated by air flow passing over a surface of the electronic apparatus; and
a wind direction detecting system, comprising:
an analyzing module that determines the facing direction where a greatest amplitude of the graph of audio data is recorded as the wind direction.

2. The electronic apparatus of claim 1, wherein the wind direction detecting system further comprises a setting module that presets at least one reference direction of the direction sensor.

3. The electronic apparatus of claim 2, wherein the setting module presets the at least one reference direction of the direction sensor by setting at least one magnetic effect value detected by the direction sensor when the electronic apparatus faces each reference direction as a reference value.

4. The electronic apparatus of claim 3, wherein the wind direction detecting system determines the facing direction of the electronic apparatus by comparing the detected magnetic effect value with the reference values.

5. The electronic apparatus of claim 3, wherein the magnetic effect is the Hall Effect.

6. The electronic apparatus of claim 1, wherein the wind direction detecting system further comprises a displaying module that displays the wind direction via a display.

7. A wind direction detecting method being performed by execution of computer readable program code by a processer of an electronic apparatus, the electronic apparatus comprising a direction sensor that detects a facing direction of the electronic apparatus and an audio collector that records a graph of audio data generated by air flow passing over a surface of the electronic apparatus, the method comprising:
recording audio data when the electronic apparatus faces different directions;
detecting the facing direction of the electronic apparatus each time the audio collector records the audio data; and
selecting the facing direction where the greatest amplitude of the graph of the audio data is recorded as the wind direction.

8. The method as claimed in claim 7, further comprising:
presetting at least one reference direction of the direction sensor before detecting the facing direction.

9. The method as claimed in claim 8, wherein the reference direction of the direction sensor is preset by setting at least one magnetic effect value detected by the direction sensor when the electronic apparatus faces each reference direction of the direction sensor as a reference value.

10. The method as claimed in claim 8, wherein the facing direction of the electronic apparatus is determined by comparing the detected magnetic effect value with the reference values.

11. The method as claimed in claim 9, wherein the magnetic effect is the Hall Effect.

12. The method as claimed in claim 7, further comprising:
displaying the wind direction via a display.
